(19) United States
(12) Patent Application Publication
(10) Pub. No.: US 2022/0261204 A1
(43) Pub. Date: Aug. 18, 2022

(54) IMAGE DISPLAY SYSTEM, IMAGE TRANSMISSION DEVICE, IMAGE DISPLAY DEVICE, AND IMAGE DISPLAY SYSTEM CONNECTION METHOD

(71) Applicant: Sharp NEC Display Solutions, Ltd., Tokyo (JP)

(72) Inventor: Ryoichi Araki, Tokyo (JP)

(21) Appl. No.: 17/623,764

(22) PCT Filed: Jul. 5, 2019
(86) PCT No.: PCT/JP2019/026810

§ 371 Date: Dec. 29, 2021

(51) Int. Cl. G06F 3/14; G06V 10/75

(52) U.S. Cl. CPC G06F 3/1454; G06V 10/751

(57) ABSTRACT

One aspect of the present invention is an image display system including an image transmission device and a plurality of image display devices communicatively connected via a network. The image transmission device includes: an image converter configured to perform conversion into first image data which is image data representing a feature of an image on the basis of an input detected image which is an image displayed by an image display device of a connection target among the plurality of image display devices; and a communicator configured to transmit the first image data to the plurality of image display devices. Each of the plurality of image display devices includes: an image converter configured to convert a displayed image into second image data; an image data determiner configured to compare the first image data received from the image transmission device with the second image data and determine whether or not the first image data matches the second image data obtained by converting the displayed image; and a communicator configured to transmit connection permission information for connecting to the image transmission device to the image transmission device in accordance with a determination result of the image data determiner.

### TECHNICAL FIELD

The present invention relates to an image display system, an image transmission device, an image display device, and an image display system connection method.

### BACKGROUND ART

In the related art, when an image display system including an image transmission device and image display devices is connected via a network, a connection is established by displaying a list of connection destinations having connection information such as names or Internet protocol (IP) addresses given to the image display devices in advance on a screen of the image transmission device and by allowing a user to select an image display device (which is a connection target) desired to be connected. In this case, because the user needs to obtain the connection information of the image display device desired to be connected, it is necessary to refer to the connection information in a menu of the image display device or refer to the connection information displayed in advance over an image displayed by the image display device. However, in both cases, there is a problem of interfering with the display of a currently displayed image. Also, there is a problem that it is difficult for the user to select a desired display device from the connection destination list when there are many display devices on the same network and there are many connection candidates.

Also, as a method for solving the above problems, there is a system in which, when an image transmission device and image display devices are connected via a network, scenery around the image display device is imaged by an image sensor of the image transmission device and is transmitted to an information processing system on a server and the information processing system connects the image transmission device and the image display device by comparing the scenery with scenery data registered in advance (see Patent Literature 1).

### CITATION LIST

### Patent Literature

[Patent Literature 1]
Japanese Unexamined Patent Application, First Publication No. 2014-056333

### SUMMARY OF INVENTION

### Technical Problem

However, in the above-described conventional example, there are many restrictions because it is necessary to register a scenery image for each image display device in advance and it is assumed that the scenery of a position of an object and the like do not change and the image display device is fixed. Also, a process of transmitting a photo itself over a network raises concerns about security issues.

The present invention has been made in view of such circumstances and an objective of the present invention is to provide an image display system, an image transmission device, an image display device, and an image display system connection method capable of connecting an image transmission device and an image display device easily and securely.

### Solution to Problem

One aspect of the present invention is an image display system including an image transmission device and a plurality of image display devices communicatively connected via a network, wherein the image transmission device includes: an image converter configured to perform conversion into first image data which is image data representing a feature of an image on the basis of an input detected image which is an image displayed by an image display device of a connection target among the plurality of image display devices; and a communicator configured to transmit the first image data to the plurality of image display devices, and wherein each of the plurality of image display devices includes: an image converter configured to convert a displayed image into second image data; an image data determiner configured to compare the first image data received from the image transmission device with the second image data and determine whether or not the first image data matches the second image data obtained by converting the displayed image; and a communicator configured to transmit connection permission information for connecting to the image transmission device to the image transmission device in accordance with a determination result of the image data determiner.

In addition, one aspect of the present invention is an image transmission device communicatively connected to a plurality of image display devices via a network, the image transmission device including: an image converter configured to perform conversion into first image data which is image data representing a feature of an image on the basis of an input detected image which is an image displayed by an image display device of a connection target among the plurality of image display devices; and a communicator configured to transmit the first image data to the plurality of image display devices.

In addition, one aspect of the present invention is an image display device communicatively connected to an image transmission device via a network, the image display device including: an image converter configured to convert a displayed image into second image data; an image data determiner configured to compare first image data received from the image transmission device with the second image data and determine whether or not the first image data matches the second image data obtained by converting the displayed image; and a communicator configured to transmit connection permission information for connecting to the image transmission device to the image transmission device in accordance with a determination result of the image data determiner.

In addition, one aspect of the present invention is a connection method of an image display system including an image transmission device and a plurality of image display devices communicatively connected via a network, the connection method including: performing, by the image transmission device, conversion into first image data which is image data representing a feature of an image on the basis of an input detected image which is an image displayed by an image display device of a connection target among the plurality of image display devices; transmitting, by the image transmission device, the first image data to the plurality of image display devices; converting, by each of the plurality of image display devices, a displayed image into second image data; comparing, by each of the plurality of image display devices, the first image data received from the image transmission device with the second image data and determining whether or not the first image data matches the second image data obtained by converting the displayed image; and transmitting, by each of the plurality of image display devices, connection permission information for connecting to the image transmission device to the image transmission device in accordance with a determination result.

### Advantageous Effects of Invention

According to an aspect of the present invention, it is possible to provide an image display system, an image transmission device, an image display device, and an image display system connection method capable of connecting an image transmission device and an image display device easily and securely.

### BRIEF DESCRIPTION OF DRAWINGS

FIG. 1 is an example of the installation/connection of an image transmission device and image display devices.

FIG. 2 is a block diagram showing an example of a configuration of an image display system according to an embodiment of the present invention.

FIG. 3 is a schematic diagram for describing the conversion of an image into small image data.

FIG. 4 is a flowchart showing an operation of the image transmission device.

FIG. 5 is a flowchart showing an operation of the image display device.

FIG. 6 is a diagram showing a minimum configuration of the image display system according to the embodiment of the present invention.

### DESCRIPTION OF EMBODIMENTS

Hereinafter, configurations of embodiments of the present invention will be described in detail with reference to the drawings of the present invention.

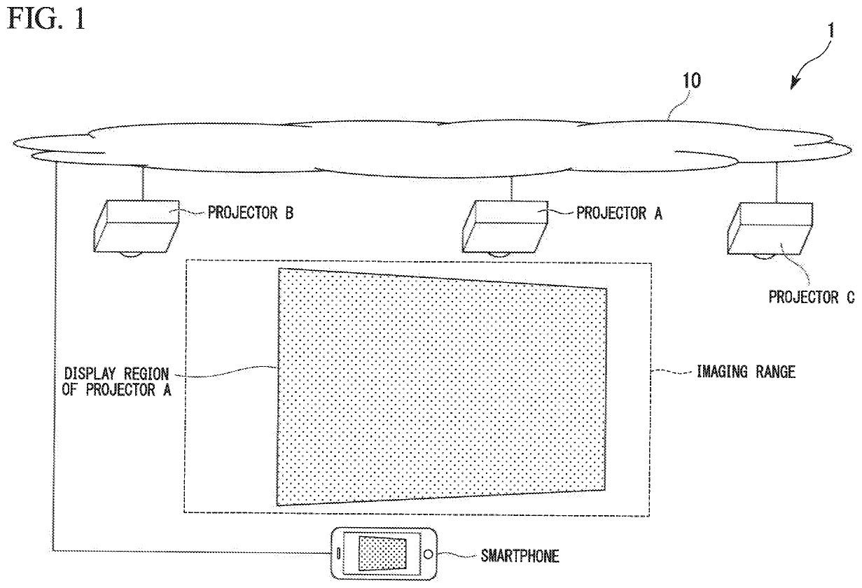

FIG. 1 is an example of the installation/connection of an image transmission device and image display devices.

As shown in FIG. 1, an image display system 1 according to an embodiment of the present invention includes a smartphone (registered trademark) and a plurality of projectors A, B, and C communicatively connected via a network 10.

Here, in the image display system 1, when an image transmission device (for example, a smartphone or a notebook PC) having an image sensor and image display devices (for example, projectors or monitors) are connected via a network, if there are a plurality of image display devices on the same network, it is possible to establish a connection to a desired image display device without referring to connection information such as an IP address by capturing an image currently displayed by an image display device (which is a connection target) desired to be connected by a user using the image sensor of the image transmission device.

As shown in FIG. 1, the projector A is an image display device (which is a connection target) desired to be connected by the user (a smartphone owner). The user images a display region (a screen) of the projector A using the image sensor of the smartphone, i.e., captures an image currently projected and displayed on the screen by the projector A.

Also, an available connection to the desired image display device will be described below. Also, in the following description, for convenience of description, the smartphone will be referred to as an image transmission device 100, and the projector A, the projector B, and the projector C will be referred to as an image display device 200A, an image display device 200B, and an image display device 200C, respectively.

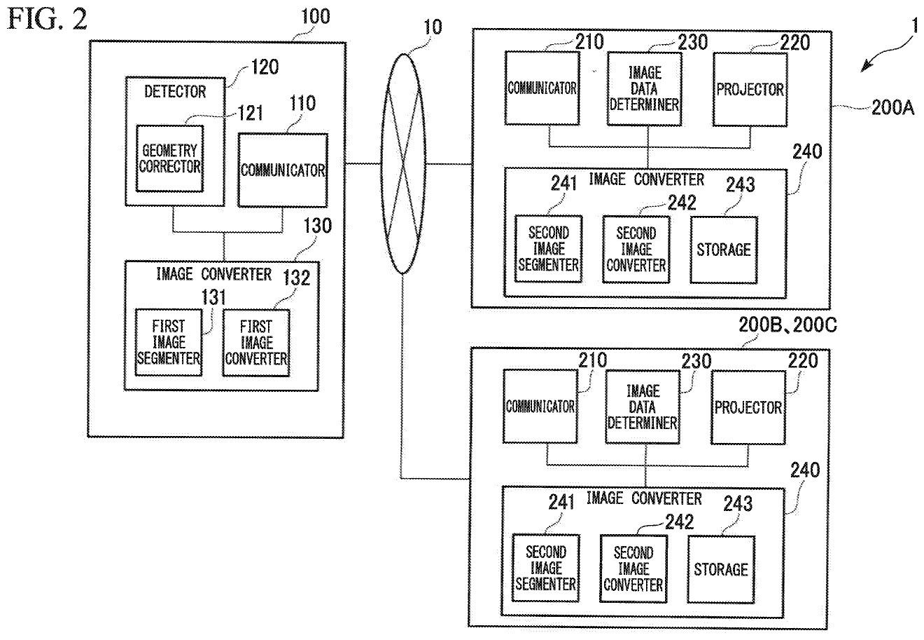

FIG. 2 is a block diagram showing an example of a configuration of an image display system according to the embodiment of the present invention.

The image transmission device 100 is configured to include a communicator 110, a detector 120, and an image converter 130.

The detector 120 detects an image displayed by the image display device (here, the image display device 200A) of the connection target among the image display device 200A, the image display device 200B, and the image display device 200C (a plurality of image display devices).

Also, it is considered that the image transmission device 100 is not limited to the case where the “detector” (the image sensor) is provided therein. For example, when the image transmission device 100 is a notebook PC, the present invention is not limited to the case where the “detector” is built into the notebook PC and an external webcam may be used as the “detector.”

Thus, the image converter 130 performs conversion into small data (first image data) which is image data representing a feature of an image on the basis of an image detected by the detector 120 or an input detected image which is an image detected by the “detector” that is an external webcam.

Hereinafter, in the description of the present embodiment, the image detected by the detector 120 will be described as the “input detected image.”

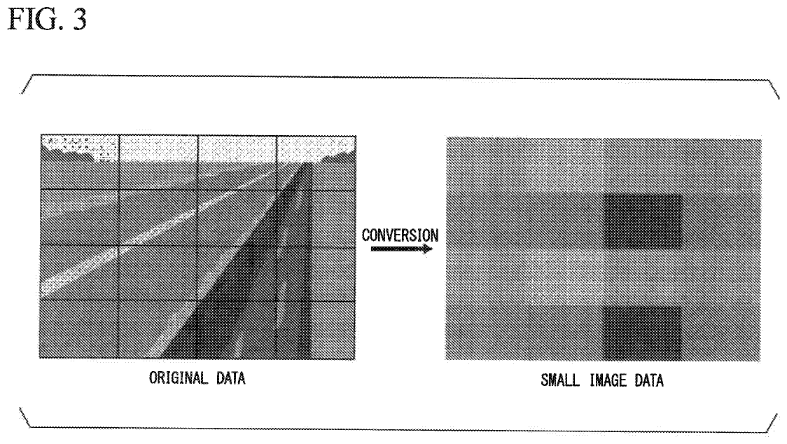

More specifically, the description will be given with reference to FIGS. 1 and 3. FIG. 3 is a schematic diagram for describing the conversion of an image into small image data.

As shown in FIG. 1, the detector 120 detects an image displayed in the display region by the image display device 200A of the connection target, geometrically corrects the detected image using a geometry corrector 121, and transmits a display image (an “original image” shown in FIG. 3) corrected to a rectangle to a first image segmenter 131 in the image converter 130.

The image converter 130 includes the first image segmenter 131 and a first image converter 132.

The first image segmenter 131 segments the detected image (the “original image” shown in FIG. 3) into a predetermined number (here, 4×4) of segment images to generate segment images.

The first image converter 132 performs a color averaging process on each of the segment images obtained in the segmentation into 4×4 and generates small image data (“small image data” shown in FIG. 3). Here, the “small image data” is “first image data having a smaller data volume than the segment images.”

Although the number of segments is 4×4=16, a larger value, for example, 8×8=64, may be used.

The communicator 110 transmits the first image data together with a “search request” to the image display device 200A, the image display device 200B, and the image display device 200C.

On the other hand, each of the image display device 200A, the image display device 200B, and the image display device 200C is configured to include a communicator 210, a projector 220, an image data determiner 230, and an image converter 240.

The projector 220 in each of the image display device 200A, the image display device 200B, and the image display device 200C acquires an image provided by a projection image provider (which is not shown in FIG. 2 and may be inside of the image display device) connected via the network 10 via the communicator 210 and actually projects the acquired image onto a screen. Of course, as will be described below, when the communicator 210 in the image display device 200A has transmitted “connection permission information” to the image transmission device 100, the image transmission device 100 transmits an image to the image display device 200A and the projector 220 in the image display device 200A projects the image onto the screen.

The image converter 240 converts a displayed image into second image data.

The image converter 240 is configured to include a second image segmenter 241, a second image converter 242, and a storage 243. It is desirable that the second image segmenter 241 and the second image converter 242 have the same configurations as the first image segmenter 131 and the first image converter 132 in the image transmission device 100.

The second image segmenter 241 segments the image projected by the projector 220 and actually displayed on the screen into a predetermined number of segment images to generate the segment images.

The second image converter 242 performs a color averaging process on each of the segment images obtained in the segmentation into the predetermined number of segment images and generates the second image data having a smaller data volume than the segment images.

Also, a display image (a displayed image) to be converted into the second image data in the image display device 200A is not limited to the above-described “image provided by the projection image provider (which is not shown in FIG. 2 and may be inside of the image display device) connected via the network 10.” For example, the image may be a display image (a displayed image) based on a video signal input to a high definition multimedia interface (HDMI) (registered trademark) terminal.

The storage 243 stores the second image data together with a point in time when the image has been displayed.

Also, the second image converter 242 generates the second image data every time the image is updated. The storage 243 deletes the second image data stored before a point in time which is a prescribed time period earlier than a current point in time, except for the second image data corresponding to the latest image.

The image data determiner 230 compares the first image data received from the image transmission device 100 with the second image data and determines whether or not the first image data matches the second image data obtained by converting the displayed image.

More specifically, when the communicator 210 has received a “search request” transmitted by the communicator 110 in the image transmission device 100 together with the first image data, the image data determiner 230 compares the first image data with all the second image data saved in the storage 243.

The communicator 210 transmits “connection permission information” for connecting to the image transmission device 100 to the image transmission device 100 in accordance with a determination result of the image data determiner 230. Specifically, if the image data determiner 230 determines that the first image data matches a piece of all the second image data saved in the storage 243 by comparing the first image data with all the second image data, the communicator 210 transmits a search response, which is a response to the “search request,” to the communicator 110 in the image transmission device. Also, when the communicator 210 has received a “connection request” transmitted in response to the “search response” received by the communicator 110 in the image transmission device 100, the communicator 210 transmits the “connection permission information” to the image transmission device 100.

From the above description, the configuration of each part of the image transmission device 100 in the image display system 1 shown in FIG. 2 and the configuration of each part in each of the image display device 200A, the image display device 200B, and the image display device 200C have been clarified.

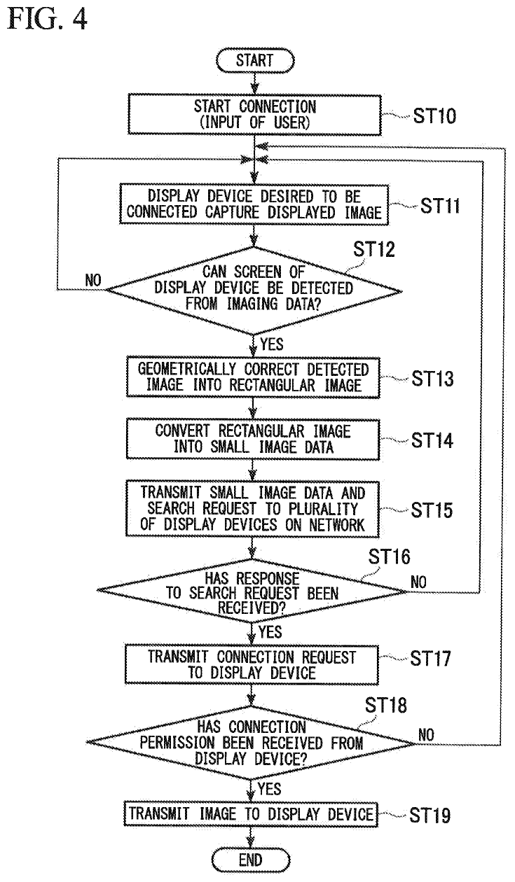

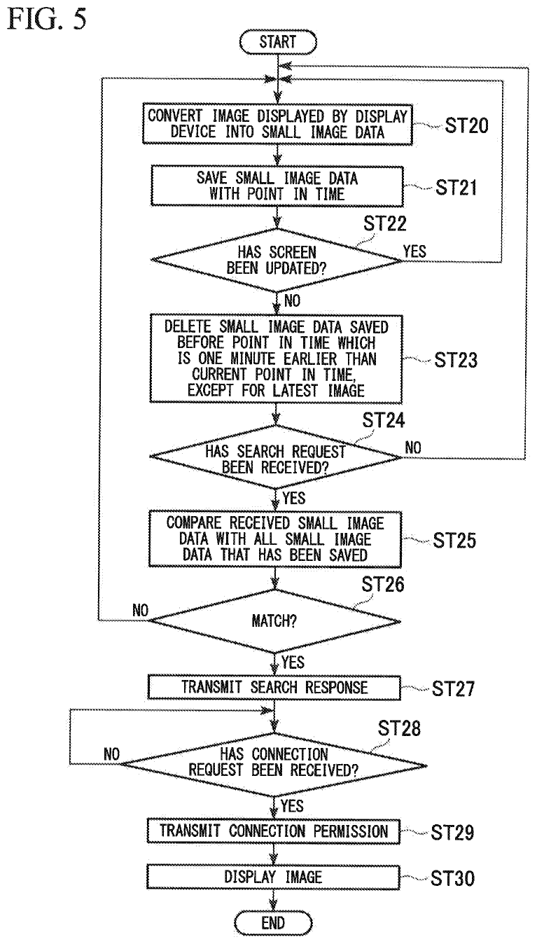

Next, an operation of the embodiment of the present invention will be described in detail with reference to FIGS. 4 and 5. FIG. 4 is a flowchart showing an operation of the image transmission device. Also, FIG. 5 is a flowchart showing an operation of the image display device.

The image transmission device 100 starts a connection according to an input from the user (step ST10). Specifically, the image transmission device 100 starts a connection to the image display device 200A according to an operation of the user.

The image transmission device 100 images a screen displayed by a display device of a connection target (step ST11).

Specifically, the detector 120 images a screen displayed by the image display device 200A.

The image transmission device 100 determines whether or not the image of the display device can be detected from imaging data (step ST12).

Specifically, the detector 120 determines whether or not the image of the image display device 200A can be detected from the imaging data, moves to step ST11 when the image of the image display device 200A cannot be detected (step ST12-No), and images a screen displayed by the image display device 200A again. On the other hand, when the image of the image display device 200A can be detected (step ST12-Yes), the process proceeds to step ST13.

The image transmission device 100 geometrically corrects the detected screen to a rectangular image (step ST13).

Specifically, the geometry corrector 121 in the detector 120 geometrically corrects the detected screen to a rectangular image and transmits the rectangular image to the first image segmenter 131 in the image converter 130.

The image transmission device 100 converts the rectangular image into small image data (step ST14).

Specifically, the first image segmenter 131 in the image converter 130 segments the image (the rectangular image) detected by the detector 120 into a predetermined number (for example, 4×4) of segment images to generate the segment images. The first image converter 132 in the image converter 130 performs a color averaging process on each of the segment images obtained in the segmentation into the predetermined number of segment images and generates small image data (first image data having a smaller data volume than the segment images).

The image transmission device 100 transmits the small image data and a search request to a plurality of display devices on the network (step ST15).

Specifically, the communicator 110 transmits the “search request” together with the first image data to the image display device 200A, the image display device 200B, and the image display device 200C (a plurality of image display devices).

Thereby, there is not much pressure on the network even if the small image data is transmitted to a large number of display devices (the plurality of image display devices 200A, 200B, and 200C) on the network 10. Also, because a photo itself of the image displayed by the image display device 200A is not transmitted, the security problem is solved.

On the other hand, in the plurality of image display devices 200A, 200B, and 200C, the processing of steps ST20 to ST24 shown in FIG. 5 is performed.

The image displayed by the display device is converted into small image data (step ST20).

Specifically, the second image segmenter 241 in the image converter 240 segments an image (a rectangular image) actually projected by the projector 220 onto the screen and displayed on the screen into a predetermined number (for example, 4×4) of segment images to generate the segment images. The second image converter 242 in the image converter 240 performs a color averaging process on each of the segment images obtained in the segmentation into the predetermined number of segment images and generates small image data (second image data having a smaller data volume than the segment images).

The small image data with a point in time is saved (step ST21).

Specifically, the storage 243 in the image converter 240 stores the second image data with a point in time.

It is determined whether or not the screen has been updated (step ST22).

Specifically, the image converter 240 determines whether or not the screen has been updated, moves to step ST20 when the screen has been updated (step ST22-Yes), and converts an image displayed by the display device into small image data again. On the other hand, when the screen has not been updated (step ST22-No), the process proceeds to step ST23.

Except for the latest image, the small image data saved before a point in time which is one minute earlier than a current point in time is deleted (step ST23).

Specifically, the second image converter 242 generates the second image data every time the image is updated. The storage 243 deletes the second image data stored before a point in time which is a prescribed time period (the above-mentioned one minute) earlier than the current point in time, except for the second image data corresponding to the latest image.

It is determined whether or not a search request has been received (step ST24).

Specifically, the image data determiner 230 determines whether or not the communicator 210 has received the “search request” transmitted by the communicator 110 in the image transmission device 100 together with the first image data. When the communicator 210 has not received the “search request” (step ST24-No), the process proceeds to step ST20 and an image displayed by the display device is converted into small image data again. On the other hand, when the communicator 210 has received the “search request” (step ST24-Yes), the process proceeds to step ST25.

The received small image data is compared with all the small image data that has been saved (step ST25).

Specifically, the image data determiner 230 compares the first image data with all the second image data saved in the storage 243.

It is determined whether or not they match (step ST26).

Specifically, the image data determiner 230 compares the first image data with all the second image data saved in the storage 243 and determines whether or not the first image data matches a piece of all the second image data. When they do not match (step ST26-No), the process proceeds to step ST20, and an image displayed by the display device is converted into small image data again. On the other hand, when they match (step ST26-Yes), the process proceeds to step ST27.

A search response is transmitted (step ST27).

Specifically, when they match, the communicator 210 transmits the “search response,” which is a response to the “search request,” to the communicator 110 of the image transmission device 100.

Subsequently, the image transmission device 100 performs the processing of steps ST16 to ST19 shown in FIG. 4 and the plurality of image display devices 200A, 200B, and 200C perform the processing of steps ST28 to ST30 shown in FIG. 5.

It is determined whether or not the response to the search request has been received (step ST16).

Specifically, it is determined whether or not the communicator 110 in the image transmission device 100 has received a “search response” that is the response to the “search request” transmitted to the plurality of image display devices 200A, 200B, 200C in step S15. When the communicator 110 has not received the “search response” (step ST16-No), the process proceeds to step ST11, and a screen displayed by the image display device 200A is imaged again. On the other hand, when the communicator 110 has received the “search response” (step ST16-Yes), the process proceeds to step ST17.

A connection request is transmitted to the display device (step ST17).

Specifically, the communicator 110 transmits the “connection request” corresponding to the “search response” to the image display device that has transmitted the received “search response.”

In this way, the image transmission device 100 can transmit the “connection request” only to the image display device that has responded to establish a connection. Here, the response is made by one image display device 200A of a target to which the image transmission device 100 is connected. However, if there are a plurality of responses, a connection destination list is displayed and the user is allowed to select a connection destination from the connection destination list as in the related art. Because it is possible to narrow down to a small number of display devices matching a feature of an image, the user can easily select the image display device 200A. Additionally, a comparison process is performed on only one piece of small image data of each of the image transmission device 100 and the image display device 200A, but the image transmission device 100 may perform imaging twice or more and a comparison process may be performed on two or more pieces of small image data, thereby improving the accuracy.

It is determined whether or not the connection request has been received (step ST28).

Specifically, it is determined whether or not the communicator 210 of the image display device 200A has received the “connection request” that is a response to the “search response” transmitted to the image transmission device 100 in step S27. When the communicator 210 has not received the “search request” (step ST28-No), the process proceeds to step ST28 and reception of the “connection request” is awaited. On the other hand, when the communicator 210 has received the “connection request” (step ST28-Yes), the process proceeds to step ST29.

Connection permission is transmitted (step ST29).

Specifically, when the “connection request” transmitted in correspondence with the “search response” (the response transmitted by the communicator 210) received by the communicator 110 in the image transmission device 100 has been received, the communicator 210 of the image display device 200A transmits the “connection permission information” to the image transmission device 100.

It is determined whether or not the connection permission has been received from the display device (step ST18).

Specifically, it is determined whether or not the communicator 110 in the image transmission device 100 has received “connection permission information” that is a response to the “connection request” transmitted to the image display device 200A in step S17. When the communicator 110 has not received the “connection permission information” (step ST18-No), the process proceeds to step ST11, and a screen displayed by the image display device 200A is imaged again. On the other hand, when the communicator 110 has received the “connection permission information” (step ST18-Yes), the process proceeds to step ST19.

An image is transmitted to the display device (step ST19).

Specifically, when the image display device 200A of a target to which the image transmission device 100 is connected has transmitted the “connection permission information,” the communicator 110 transmits an image to the image display device 200A of the connection target.

The image is displayed (step ST30).

Specifically, the image display device 200A displays the image transmitted by the communicator 110 of the image transmission device 100.

As described above, according to the image display system 1 of the present embodiment, when the user connects the image display device 200A and the image transmission device 100 via the network 10, it is possible to uniquely select a display device to be connected without referring to connection information such as an IP address. Also, according to the image display system 1, when the user connects the image display device 200A and the image transmission device 100 via the network 10, the number of candidates for the display device to be connected can be narrowed down.

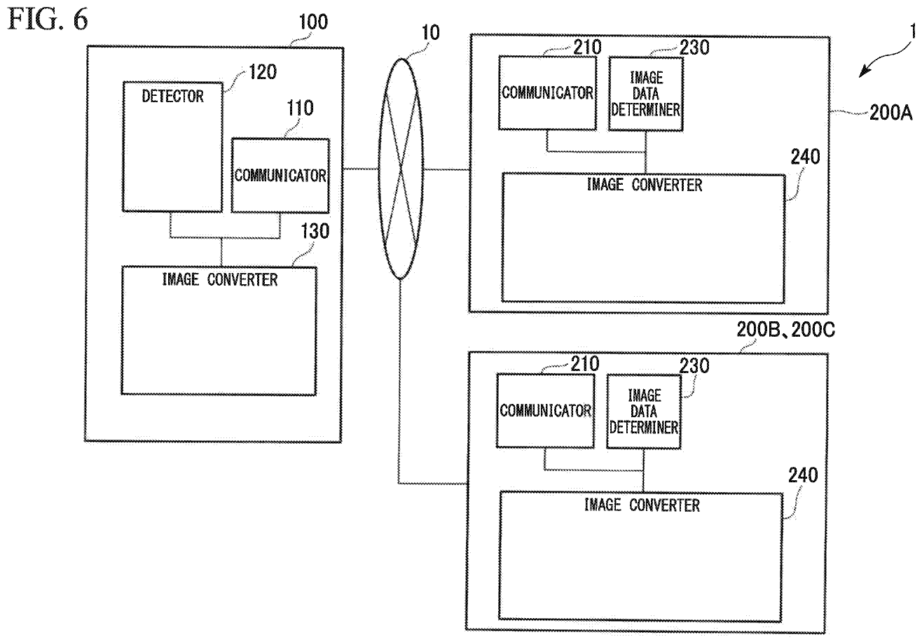

Next, a minimum configuration of the above embodiment will be described with reference to FIG. 6. FIG. 6 is a diagram showing a minimum configuration of the image display system according to the embodiment of the present invention.

The image display system 1 is an image display system including the image transmission device 100, the image display device 200A, the image display device 200B, and the image display device 200C (a plurality of image display devices) communicatively connected via the network 10.

The image transmission device. 100 includes the image converter 130 configured to perform conversion into first image data which is image data representing a feature of an image on the basis of a detected image (an image detected by the detector 120 or an input detected image which is an image detected by the “detector” that is an external webcam) which is an image displayed by and input from the image display device 200A of a connection target among the plurality of image display devices; and the communicator 110 configured to transmit the first image data to the plurality of image display devices.

Each of the plurality of image display devices includes the image converter 240 configured to convert a displayed image into second image data; the image data determiner 230 configured to compare the first image data received from the image transmission device 100 with the second image data and determine whether or not the first image data matches the second image data obtained by converting the displayed image; and the communicator 210 configured to transmit connection permission information for connecting to the image transmission device 100 to the image transmission device 100 in accordance with a determination result of the image data determiner 230.

As described above, according to the embodiment of the present invention and the minimum configuration example, it is possible to provide an image display system, an image transmission device, an image display device, and an image display system connection method capable of connecting an image transmission device and an image display device easily and securely.

Although embodiments of the present invention have been described above with reference to the drawings, specific configurations are not limited to the embodiments and other designs and the like may also be included without departing from the scope of the present invention. Also, a part or all of a program to be executed by a computer of one or more CPUs and the like provided in the above embodiment can be distributed via a communication circuit or a computer-readable recording medium.

Also, the following appendixes will be further disclosed in relation to the above description.

### (Appendix 1)

A connection method of an image transmission device communicatively connected to a plurality of image display devices via a network, the connection method including:

an image conversion step of performing conversion into first image data which is image data representing a feature of an image on the basis of an input detected image which is an image displayed by an image display device of a connection target among the plurality of image display devices; and

a communication step of transmitting the first image data to the plurality of image display devices.

### (Appendix 2)

A program for use in an image transmission device communicatively connected to a plurality of image display devices via a network, the program causing a computer to execute:

an image conversion process of performing conversion into first image data which is image data representing a feature of an image on the basis of an input detected image which is an image displayed by an image display device of a connection target among the plurality of image display devices; and

a communication process of transmitting the first image data to the plurality of image display devices.

### (Appendix 3)

A connection method of an image display device communicatively connected to an image transmission device via a network, the connection method comprising:

an image conversion step of converting a displayed image into second image data;

an image data determination step of comparing first image data received from the image transmission device with the second image data and determining whether or not the first image data matches the second image data obtained by converting the displayed image; and

a communication step of transmitting connection permission information for connecting to the image transmission device to the image transmission device in accordance with a determination result.

### (Appendix 4)

A program for use in an image display device communicatively connected to an image transmission device via a network, the program causing a computer to execute:

an image conversion process of converting a displayed image into second image data;

an image data determination process of comparing first image data received from the image transmission device with the second image data and determining whether or not the first image data matches the second image data obtained by converting the displayed image; and

a communication process of transmitting connection permission information for connecting to the image transmission device to the image transmission device in accordance with a determination result.

### REFERENCE SIGNS LIST

1 Image display system
10 Network
100 Image transmission device
110, 210 Communicator
120 Detector
121 Geometry corrector
130, 240 Image converter
131 First image segmenter
132 First image converter
200A, 200B, 200C Image display device
220 Projector
230 Image data determiner
241 Second image segmenter
242 Second image converter
243 Storage

1. An image display system comprising an image transmission device and a plurality of image display devices communicatively connected via a network,
wherein the image transmission device comprises:
an image converter configured to perform conversion into first image data which is image data representing a feature of an image on the basis of an input detected image which is an image displayed by an image display device of a connection target among the plurality of image display devices; and
a communicator configured to transmit the first image data to the plurality of image display devices, and
wherein each of the plurality of image display devices comprises:
an image converter configured to convert a displayed image into second image data;
an image data determiner configured to compare the first image data received from the image transmission device with the second image data and determine whether or not the first image data matches the second image data obtained by converting the displayed image; and
a communicator configured to transmit connection permission information for connecting to the image transmission device to the image transmission device in accordance with a determination result of the image data determiner.

2. The image display system according to claim 1, wherein the image converter in the image transmission device comprises:
a first image segmenter configured to segment the input detected image into a prescribed number of segment images and generate the segment images; and
a first image converter configured to perform a color averaging process on each of the prescribed number of segment images obtained in the segmentation and generate the first image data having a smaller data volume than the segment images.

3. The image display system according to claim 1, wherein the image converter in each of the plurality of image display devices comprises:
a second image segmenter configured to segment the displayed image into a prescribed number of segment images and generate the segment images; and
a second image converter configured to perform a color averaging process on each of the prescribed number of segment images obtained in the segmentation and generate the second image data having a smaller data volume than the segment images.

4. The image display system according to claim 1,
wherein the image converter in each of the plurality of image display devices comprises a storage configured to store the second image data together with a point in time at which the image has been displayed,
wherein the second image converter generates the second image data every time the image is updated, and
wherein the storage deletes the second image data stored before a point in time which is a prescribed time period earlier than a current point in time, except for the second image data corresponding to the latest image.

5. The image display system according to claim 4, wherein, when a search request transmitted by the communicator in the image transmission device together with the first image data has been received by the communicator in each of the plurality of image display devices,
when an image data determiner in each of the plurality of image display devices determines that the first image data matches a piece of all the second image data saved in the storage by comparing the first image data with all the second image data,
the communicator in each of the plurality of image display devices transmits a search response, which is a response to the search request, to the communicator in the image transmission device.

6. The image display system according to claim 5, wherein the communicator in each of the plurality of image display devices transmits the connection permission information to the image transmission device when a connection request transmitted in correspondence with the search response received by the communicator in the image transmission device has been received.

7. The image display system according to claim 1,
wherein the communicator in the image transmission device transmits an image to the image display device of the connection target when the image display device of the connection target has transmitted the connection permission information, and
wherein the image display device displays the image.

8. An image transmission device communicatively connected to a plurality of image display devices via a network, the image transmission device comprising:
an image converter configured to perform conversion into first image data which is image data representing a feature of an image on the basis of an input detected image which is an image displayed by an image display device of a connection target among the plurality of image display devices; and
a communicator configured to transmit the first image data to the plurality of image display devices.

9. An image display device communicatively connected to an image transmission device via a network, the image display device comprising:
an image converter configured to convert a displayed image into second image data;
an image data determiner configured to compare first image data received from the image transmission device with the second image data and determine whether or not the first image data matches the second image data obtained by converting the displayed image; and
a communicator configured to transmit connection permission information for connecting to the image transmission device to the image transmission device in accordance with a determination result of the image data determiner.

10. A connection method of an image display system including an image transmission device and a plurality of image display devices communicatively connected via a network, the connection method comprising:
performing, by the image transmission device, conversion into first image data which is image data representing a feature of an image on the basis of an input detected image which is an image displayed by an image display device of a connection target among the plurality of image display devices;
transmitting, by the image transmission device, the first image data to the plurality of image display devices;
converting, by each of the plurality of image display devices, a displayed image into second image data;
comparing, by each of the plurality of image display devices, the first image data received from the image transmission device with the second image data and determining whether or not the first image data matches the second image data obtained by converting the displayed image; and
transmitting, by each of the plurality of image display devices, connection permission information for connecting to the image transmission device to the image transmission device in accordance with a determination result.
